(19) United States
(12) Patent Application Publication
(10) Pub. No.: US 2011/0228118 A1
(43) Pub. Date: Sep. 22, 2011

(54) METHOD OF EXTRACTING A 3D IMAGE

(76) Inventor: Chien-Mo LAI, Sanchung City (TW)

(21) Appl. No.: 12/969,630

(22) Filed: Dec. 16, 2010

(30) Foreign Application Priority Data
Mar. 22, 2010 (TW) 099108314

(51) Int. Cl. H04N 5/228

(52) U.S. Cl. 348/222.1; 348/E05.031

(57) ABSTRACT

The present invention discloses a method of extracting a 3D image having steps of providing a movable optical lens assembly on an imaging path between a single lens and a single image sensor; controlling the moveable optical lens assembly to move repeatedly to make the single image sensor obtain different 2D images with parallaxes through the moveable optical lens assembly; and combining the 2D images with parallaxes to extract a 3D image. Therefore, the present invention reduces cost of extracting 3D images and controlling complexity of extracting 3D images.

### BACKGROUND OF THE INVENTION

1. Field of the Invention

The present invention relates to the field of an image extracting method, and more particularly to a method of extracting a 3D image.

2. Description of Related Art

Nowadays technologies change from day to day, and people pursue video and audio signals of high resolution quality. The color television is developed to replace the monochrome television, and then a HDTV is proposed to provide people with better visual enhancement. At present, some of the television companies market a 3D television that can display 3D images. People enjoy a more vivid sense of visual reality by watching the 3D videos. Therefore, technique of extracting 3D images becomes an important issue for 3D-related companies.

With reference to FIG. 3, a schematic view shows a conventional 3D image extracting method. Since one 3D image of a real subject, such as an article, landscape or people, is generated by combining different 2D images of the subject, the 2D images are obtained at different angles relative to the subject, so multiple image extractors 50 are required. Each image extractor 50 has a lens 51 and an image sensor 52. The lenses 51 of the image extractors 50 are respectively aligned to the same subject according to the corresponding angle to extract the 2D images at the same time. Since parallax exists between the 2D images, the 3D image is generated by combining the 2D images.

Based on the foregoing description, numerous image extractors are required and put on positions at different angles around the subject to get 2D images with parallaxes for extracting the 3D image. Therefore, it costs high to buy the multiple image extractors and to adopt a complex controlling process to synchronously drive the image extractors to take 2D images at the same time.

To overcome the shortcomings, the present invention provides a method of extracting a 3D image to mitigate or obviate the aforementioned problems.

### SUMMARY OF THE INVENTION

Based on foregoing drawbacks of the conventional method of extracting a 3D image, the main objective of the present invention is to provide a method of extracting a 3D image having low cost and a simplified controlling process.

The method of extracting a 3D image has steps of providing a movable optical lens assembly on an imaging path between a single lens and a single image sensor; controlling the moveable optical lens assembly to move repeatedly to make the single image sensor obtain different 2D images with parallaxes through the moveable optical lens assembly, and combining the 2D images with parallaxes to extract a 3D image. Therefore, the present invention reduces cost of extracting 3D images and controlling complexity of extracting 3D images.

Other objectives, advantages and novel features of the invention will become more apparent from the following detailed description when taken in conjunction with the accompanying drawings.

### BRIEF DESCRIPTION OF THE DRAWINGS

FIG. 1 is a schematic view of implementing a method of extracting a 3D image in accordance with the present invention;

FIGS. 2A to 2C are schematic views of extracting 2D images with parallax using the method of extracting a 3D image in accordance with the present invention; and

FIG. 3 is a schematic view of extracting 2D images with parallax using the method of extracting a 3D image in accordance with the prior art.

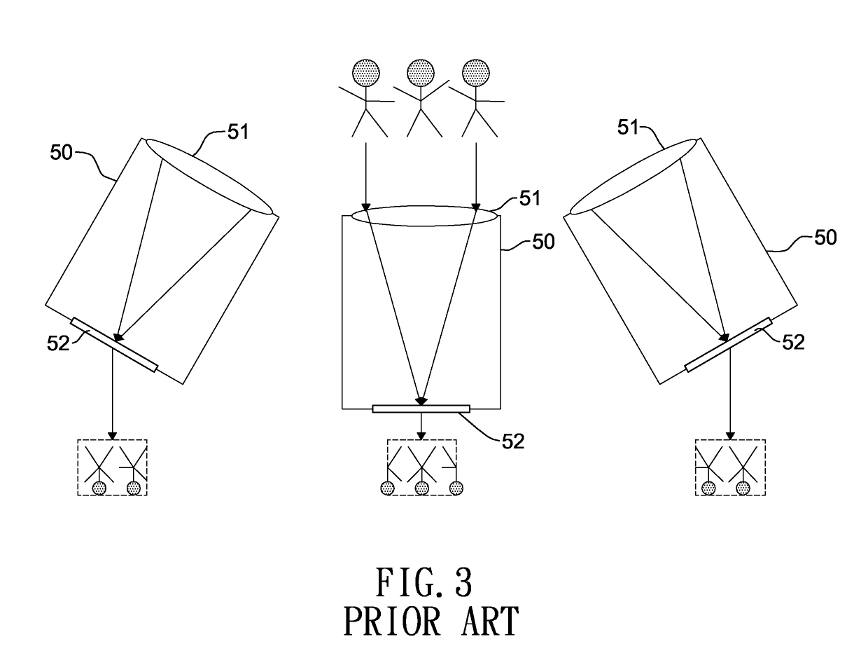

### DETAILED DESCRIPTION OF THE PREFERRED EMBODIMENT

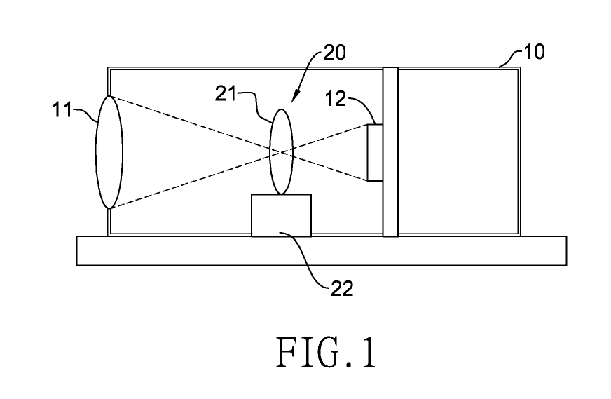

With reference to FIG. 1, an image extracting device 10 to implement a method of extracting a 3D image in accordance with the present invention has a single lens 11, a signal image sensor 12 and a movable optical lens assembly 20. The movable optical lens 20 assembly is moveably mounted between the single lens 11 and the single image sensor 12 and moves horizontally and repeatedly between the single lens 11 and the single image sensor 12. Therefore, the image sensor 12 obtains multiple 2D images with parallaxes to be combined for extracting the 3D image through the moveable optical lens assembly 20 and the single lens 11.

The movable optical lens assembly 20 has an optical lens 21 and a movable module 22.

The optical lens 21 is mounted on an imaging path 101 between the single lens 11 and the single image sensor 12, so lights traveling through the single lens 11 are passing through the optical lens 21. The optical lens 21 may be a convex lens, concave lens, a prism lens, or the like.

The movable module 22 is connected to the optical lens 21 and receives an external controlling signal to move in a horizontal direction, so the optical lens 21 may move horizontally with the movable module 20. The movable module 22 has an electromagnetic motor, a stepping motor, a voice coil motor or the like.

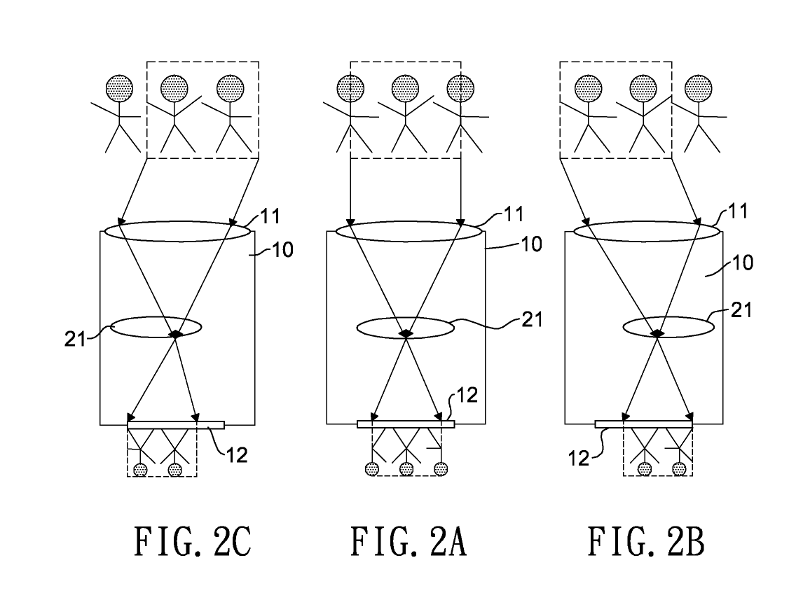

With further reference to FIG. 2A to 2C, the moveable optical lens assembly 20 is controlled to move three times to describe how the image sensor 12 obtains the multiple 2D images with parallaxes.

The movable optical lens assembly 20 is firstly controlled to align with the single lens 11 and the single image sensor 12, so the image sensor 12 obtains a front elevation 301 of an subject 30 in 2D image as shown in FIG. 2A. Further, the movable optical lens assembly 20 is controlled to horizontally move to the right, so the optical lens 21 refracts lights from the left side 302 of the subject 30 to the single image sensor 12. At the same time, the image sensor 12 senses the lights from the left side 302 of the subject 30 and obtains a left side view of the subject 30 in 2D image through the optical lens 21 and the single lens 11 as shown in FIG. 2B. The movable optical lens assembly 20 is further controlled to horizontally move to the left, so the optical lens 21 refracts lights from the right side of the subject 30 to the single image sensor 12. At the same time, the image sensor 12 senses the lights from the left side of the subject 30 and obtains a right side view 303 of the subject 30 in 2D image through the optical lens 21 and the single lens 11 as shown in FIG. 2C. By controlling the moveable optical lens assembly 20, the single image sensor 12 obtains the different 2D images of the subject 30. Since the 2D images are taken with parallaxes, a 3D image of the subject 30 is extracted by combining the three 2D images. To further generate a more accurate and lifelike 3D image of the subject, the moveable optical assembly is controlled to repeat more horizontal movements and the single image sensor 12 can obtain more 2D images with parallaxes of the subject 30.

Based on the foregoing description, the moveable optical lens assembly is moveably mounted on the imaging path between the single lens and the single image sensor, so the single image sensor obtains 2D images with parallaxes by only controlling the moveable optical lens assembly to move horizontally and repeatedly. The 3D image is extracted by combining the 2D images. Therefore, the present invention does not require multiple image extracting devices and reduces cost of extracting 3D images and controlling complexity of extracting 3D images. The imaging sequence and movement sequence of the moveable optical lens assembly mentioned above are variable and not limited by the foregoing description of the foregoing embodiment.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A method of extracting a 3D image comprising:
providing a movable optical lens assembly on an imaging path between a single lens and a single image sensor;
controlling the moveable optical lens assembly to move repeatedly, so the single image sensor obtains different 2D images with parallaxes through the moveable optical lens assembly; and
combining the 2D image with parallaxes to extract a 3D image.

2. The extracting method as claimed in claim 1, wherein the moveable optical lens assembly comprises:
an optical lens mounted on the imaging path between the single lens and the single image sensor, wherein lights traveling through the single lens are passing through the optical lens; and
a movable module connected to the optical lens and receiving an external controlling signal to move.

3. The extracting method as claimed in claim 2, wherein the optical lens is a convex lens or a concave lens.

4. The extracting method as claimed in claim 2, wherein the optical lens is a prism lens.

5. The extracting method as claimed in claim 2, wherein the movable module has an electromagnetic motor.

6. The extracting method as claimed in claim 2, wherein the movable module has a stepping motor.

7. The extracting method as claimed in claim 2, wherein the movable module has a voice coil motor.

8. A method of extracting a 3D image comprising:
providing an movable optical lens assembly on an imaging path between a single lens and a single image sensor;
controlling the moveable optical lens assembly to move horizontally and repeatedly, so the single image sensor obtains different 2D images with parallaxes through the moveable optical lens assembly; and
combining the 2D images with parallaxes to extract a 3D image.

9. The extracting method as claimed in claim 8, wherein the moveable optical lens assembly comprises:
an optical lens mounted on the imaging path between the single lens and the single image sensor, wherein lights traveling through the single lens are passing through the optical lens; and
a movable module connected to the optical lens and receiving an external controlling signal to move horizontally.
